(19) United States
(12) Patent Application Publication
(10) Pub. No.: US 2012/0006883 A1
(43) Pub. Date: Jan. 12, 2012

(54) APPARATUS AND METHOD FOR FRICTION STIR WELDING

(75) Inventors: Hidehito Nishida, Kobe-Shi (JP); Mitsuo Fujimoto, Kobe-shi (JP); Mitsuhiro Kamioka, Kobe-Shi (JP); Hideki Okada, Kakamigahara-Shi (JP)

(73) Assignee: KAWASAKI JUKOGYO KABUSHIKI KAISHA, KOBE-SHI, HYOGO-KEN (JP)

(21) Appl. No.: 13/255,741

(22) PCT Filed: Feb. 26, 2010
(86) PCT No.: PCT/JP2010/053109

§ 371 Date: Sep. 9, 2011

(30) Foreign Application Priority Data
Mar. 16, 2009 (JP) 2009-062627

(51) Int. Cl. B23K 20/12; B23K 37/00

(52) U.S. Cl. 228/112.1; 228/2.1

(57) ABSTRACT

The apparatus includes a welding head having a welding tool to be pressed against workpieces and a rotation drive unit to drive the welding tool to be rotated; a head drive unit to drive the welding head to be displaced, the head drive unit including a cylinder actuator having a piston rod to which the welding head is attached; a first pressure unit to supply a pressure fluid into a first chamber of the cylinder actuator; a second pressure unit to supply a pressure fluid into a second chamber of the cylinder actuator; a control unit to control pressures of respective pressure fluids supplied by the first pressure unit and the second pressure unit.

### TECHNICAL FIELD

The present invention relates to friction stir welding apparatus and method, specifically for welding workpieces by pressing a rotating welding tool against the workpieces so as to cause a plasticized fluidization.

### BACKGROUND ART

In these years, a friction stir welding apparatus is used in a wide variety of areas, such as a railroad car body, a ship, an aircraft, and a bridge.

As a typical example of conventional friction stir welding apparatus, there is an apparatus in which a welding tool is pressed against one face of workpieces to be welded while the welding tool is being rotated, thereby, causing a plasticized fluidization at the welded portion so that both workpieces are welded when the materials mixed by the plasticized fluidization become solid (Patent Document 1). As a means for achieving a pressing force of the welding tool, in Patent Document 1, a pressing-type air cylinder is used.

FIG. 8 shows a schematic diagram of a friction stir welding apparatus of this type. This apparatus 100 includes a welding head 103 which is mounted on a head support part 101 of an apparatus body via a linear guide 102 so as to be linearly movable in the upward and downward directions. A welding tool 104 is rotatably mounted on the welding head 103, the welding tool 104 being configured to be made contact with the upper face of workpieces P during an operation. The welding tool 104 is driven to rotate by means of a tool rotation drive motor 105 which is mounted on the welding head 103.

An air cylinder 106 for driving a head is fixedly mounted on the head support part 101. The welding head 103 is attached to a piston rod 106A of the air cylinder 106. Compressed air is supplied from a compressed air source 120 via a pressure-side pipe 109 into a pressure chamber 107 of the air cylinder 106. On the other hand, a backpressure-side pipe 121 is connected to a backpressure chamber 108 of the air cylinder 106.

A pressure control valve 122 and an electromagnetic valve 123 are disposed in the middle of the pressure-side pipe 109. The backpressure-side pipe 121 is also connected to the electromagnetic valve 123 so that the backpressure chamber 108 of the air cylinder 106 can be opened to an atmosphere by switching the electromagnetic valve 123. The pressure control valve 122 and the electromagnetic valve 123 are controlled by a control unit 124.

By the way, the conventional friction stir welding apparatus 100 shown in FIG. 8 has a system in which the welding tool 104 is pressed against one face of the workpieces P to be welded. Accordingly, as shown in FIG. 9, the workpieces P need to be supported on its rear side by placing a backing metal 125 on the rear side of the workpieces P.

Therefore, there are many restrictions about the shapes of members (such as the shape of coupling) which can be welded by means of the apparatus of this type. Thereby, the objects which can be treated by the apparatus of this type are restricted. Moreover, there needs to be a high rigidity for a plate surface on which the workpieces P are fixed, and the fixing jigs are also large-scale. Thereby, the apparatus becomes expensive, and the handling thereof is not always easy to be performed.

In order to address the above-mentioned problems, a friction stir welding apparatus of bobbin tool has been developed in order to make such backing metals and large-scale fixing jigs unnecessary (Patent Document 2). As shown in FIGS. 10 and 11, the friction stir welding apparatus 200 of this type of bobbin tool is provided with a welding tool 201. The welding tool 201 includes a pair of upper and lower rotational members 201A, 201B which are disposed with a fixed space therebetween so as to sandwich the front and rear faces of the workpieces P to be welded, and a stirring shaft 201C disposed between the upper and lower rotational members 201A, 201B.

When the abutted portions of the workpieces P are welded by means of this bobbin tool type apparatus, the welding tool 201 is moved along the abutment line L between the workpieces P while the welding tool 201 is being rotated. Thereby, a frictional heat is generated on the front and rear faces of the workpieces P to be welded and the abutted face thereof so as to cause a plasticized fluidization. After the welding tool 201 has passed, the abutted portions of the workpieces P which have been mixed with each other by the plasticized fluidization become solid, thereby the workpieces P are welded with each other.

According to the friction stir welding apparatus 200 of this bobbin tool type, the constitution of the apparatus is simplified since the backing metals become unnecessary, and the restrictive conditions for the members to be welded become less restrictive. Moreover, a poor welding condition at the rear face of the workpieces P can be prevented by causing plasticized fluidizations on both front and rear faces of the workpieces P.

As explained above, the aforementioned bobbin tool type apparatus uses a fixed-type bobbin tool in which the distance between the upper and lower rotational members of the welding tool is fixed. The fixed bobbin tool is moved along the abutment line of the workpieces to be welded. However, this apparatus is not provided with a function for controlling the position of the bobbin tool in the upward and downward directions so as to follow the faces (upper/lower faces) of the workpieces. Namely, the welding operation by means of the fixed-bobbin tool is performed according to a positional control operation based on a preliminary taught path.

Therefore, even when the positions of the faces of the members to be welded in the upward/downward directions locally change (corrugate), it is impossible to adjust the positions of the bobbin tool in the upward/downward directions according to the positional changes of the faces of the members to be welded. As a result, a poor welding may be caused at the portions, and the strength of the welded portions may be inconstant.

In order to address this problem, a friction stir welding apparatus using a bobbin tool of self-reacting type which makes it possible to change the distance between the upper and lower rotational members has been developed (Patent Documents 3, 4). In the apparatus of this type, the grasping force between the upper rotational member (upper shoulder) and the lower rotational member (lower shoulder) is controlled by a force control system using a hydraulic pressure. The upper rotational member and the lower rotational member can be made to respectively follow the faces (upper/lower faces) of the workpieces to be welded.

However, in this apparatus using a bobbin tool of self-reacting type, the welding head has a constitution including three shafts which comprises two pressing shafts for the upper/lower rotational members (shoulders) and one rotation shaft for the welding tool. Therefore, the constitution becomes complicated and expensive.

Therefore, it is desired for a friction stir welding apparatus of bobbin tool type to be able to appropriately address the changes of the positional relationship in the upward/downward directions between the bobbin tool and the workpieces to be welded due to the size errors and the mounting errors, even when using a fixed-type bobbin tool.

There are some cases that the friction stir welding apparatus of bobbin tool mentioned above cannot appropriately weld workpieces, depending on the kinds (shapes, materials, etc.) of the workpieces. Even in such cases, the friction stir welding apparatus 100 of one-side pressing type shown in FIGS. 8 and 9, in which the welding tool 104 is pressed against one side of the workpieces P, may be able to weld the workpieces without any troubles.

Therefore, it is desired to make it possible for the same friction stir welding apparatus to switch the conventional one-side pressing welding and the bobbin tool type welding by appropriately changing the welding tools.

However, the conventional friction stir welding apparatus of one-side pressing welding uses an air cylinder for generating the pressing force of the welding tool. Therefore, it is difficult or impossible for the conventional apparatus to hold the welding tool at a desired position of height by simply replacing the conventional welding tool with a bobbin tool type welding tool.

On the other hand, the friction stir welding apparatus of fixed bobbin tool type is not provided with a means for generating a strong pressing force, such as an air cylinder of the friction stir welding apparatus of one-side pressing type. Therefore, it is impossible to achieve an appropriate welding condition by simply replacing the welding tool of fixed bobbin tool type with the welding tool of one-side pressing type.

Moreover, for the conventional friction stir welding apparatus using the welding tool of one-side pressing type, it is difficult or impossible to achieve a pressing force (of the welding tool) which is appropriate as a welding condition in which members of relatively soft materials, such as plastic materials, or thin members are to be welded.

The conventional friction stir welding apparatus mentioned above is constituted to press the welding tool against the workpieces to be welded by means of the pressing type air cylinder. Therefore, the pressing force applied to the workpieces will be the sum of the pressing force by the air cylinder and the downward force due to the own weight of the welding head including the welding tool.

Therefore, even when the air cylinder is made off so as to make the pressing force thereof zero, at least the pressing force due to the own weight of the welding head is inevitably applied to the workpieces to be welded. As a result, it is impossible to apply a pressing force which is low enough for welding members of soft materials or thin members.

### RELATED ART DOCUMENTS

### Patent Documents

Patent Document 1: JP3261431B

Patent Document 2: JP2712838B

Patent Document 3: JP2008-149331A

Patent Document 4: JP4175484B

### DISCLOSURE OF THE INVENTION

The present invention has been made taking into account the above-mentioned situations to provide friction stir welding apparatus and method which are able to perform an appropriate friction stir welding for many kinds of workpieces to be welded having different materials or shapes.

In order to solve the above-mentioned problems, a friction stir welding apparatus according to the present invention comprises: a welding head including a welding tool configured to be pressed against workpieces to be welded and a rotation drive unit configured to drive the welding tool to be rotated; a head drive unit configured to drive the welding head to be displaced, the head drive unit including a cylinder actuator having a piston rod to which the welding head is attached; a first pressure unit configured to supply a pressure fluid into a first chamber of the cylinder actuator; a second pressure unit configured to supply a pressure fluid into a second chamber of the cylinder actuator; a control unit configured to control pressures of respective pressure fluids which are simultaneously supplied into the first chamber and the second chamber by means of the first pressure unit and the second pressure unit.

Preferably, the welding tool is a fixed-type bobbin tool including a pair of rotational members which are disposed with a fixed space therebetween and a stirring shaft disposed between the pair of rotational members.

Preferably, the welding tool is configured to be pressed against only one side of the workpieces.

Preferably, the control unit is configured to control each of the pressures so that at least a part of a weight of the welding head is supported by a pressure difference between the pressure of the pressure fluid supplied from the first pressure unit and the pressure of the pressure fluid supplied from the second pressure unit.

Preferably, the first pressure unit and the second pressure unit are provided with a common pressure fluid source.

Preferably, the apparatus further comprises a tool position correction mechanism configured to displace the welding tool so as to follow a surface shape of the workpieces, the tool position correction mechanism including a contact member configured to be made contact with a surface of the workpieces and an elastic support unit configured to elastically support the contact member with respect to the welding head.

Preferably, the elastic support unit includes a compression spring or a cylinder actuator.

Preferably, the apparatus further comprises a head retaining mechanism configured to press the welding head in a direction moving away from the workpieces so as to retain the welding head at a given position.

Preferably, the head retaining mechanism includes a cylinder actuator having a piston rod which is made contact with the welding head.

Preferably, the control unit further has a switching mechanism configured to switch a control mode in which the respective pressure fluids are simultaneously supplied into the first chamber and the second chamber to an additional control mode in which the pressure fluid is supplied into only one of the first chamber and the second chamber.

Preferably, the additional control mode is a mode in which the workpieces are pressed by the welding tool configured to be pressed against only one side of the workpieces.

Preferably, the additional control mode is a mode in which at least a part of a weight of the welding head is supported by a pressure of the pressure fluid.

In order to solve the above-mentioned problems, a friction stir welding method of welding workpieces by pressing a rotating welding tool against the workpieces so as to cause a plasticized fluidization, comprises: a pressure control step of controlling pressures of respective pressure fluids which are simultaneously supplied to a first chamber and a second chamber of a cylinder actuator, the cylinder actuator including a piston rod to which a welding head having the welding tool is attached; and a tool moving step of moving the welding tool along a welding line of the workpieces while the pressures of the respective pressure fluids are being controlled by the pressure control step.

Preferably, a fixed-type bobbin tool is used as the welding tool, the fixed-type bobbin tool including a pair of rotational members which are disposed with a fixed space therebetween and a stirring shaft mounted between the pair of rotational members.

Preferably, the welding tool is a welding tool configured to be pressed against only one side of the workpieces.

Preferably, at least a part of a weight of the welding head is supported by a pressure difference between the pressure of the pressure fluid supplied into the first chamber of the cylinder actuator and the pressure of the pressure fluid supplied into the second chamber.

Preferably, in the tool moving step, the welding tool is displaced so as to follow a surface shape of the workpiece.

Preferably, when a welding operation is started, the welding head is pressed in a direction moving away from the workpieces so as to retain the welding head at a given position.

Preferably, after a welding condition has become stable, a retention of the welding head at the given position is released.

According to the present invention, the pressure fluids can be simultaneously supplied into both chambers of the cylinder actuator having a piston to which the welding tool is attached, and the pressures of respective pressure fluids supplied into both chambers can be controlled, so that an appropriate friction stir welding can be performed for many kinds of workpieces to be welded having different materials or shapes.

### BRIEF DESCRIPTION OF THE DRAWINGS

FIG. 1 is a schematic diagram showing a friction stir welding apparatus according to an embodiment of the present invention.

FIG. 2 is a schematic diagram showing a friction stir welding apparatus which is provided with a welding tool of one-side pressing type, as a modification of the embodiment shown in FIG. 1.

FIG. 3 is a schematic diagram showing a friction stir welding apparatus which is provided with a tool position correction mechanism having a compression spring, as another modification of the embodiment shown in FIG. 1.

FIG. 4 is a schematic diagram showing a friction stir welding apparatus which is provided with a tool position correction mechanism having an air cylinder, as another modification of the embodiment shown in FIG. 1.

FIG. 5 is a schematic diagram showing a friction stir welding apparatus which is provided with a tool position correction mechanism on the lower face side of the workpieces to be welded, as another modification of the embodiment shown in FIG. 1.

FIG. 6 is a schematic diagram showing a friction stir welding apparatus which is provided with a head holding mechanism, as another modification of the embodiment shown in FIG. 1.

FIG. 7 is a schematic diagram showing a friction stir welding apparatus which is provided with a tool position correction mechanism and a head holding mechanism, as another modification of the embodiment shown in FIG. 1.

FIG. 8 is a schematic diagram showing an apparatus of one-side pressing type, as an example of the conventional friction stir welding apparatus.

FIG. 9 is a diagram for explaining the welding operations by the conventional friction stir welding apparatus shown in FIG. 8.

FIG. 10 is a diagram for explaining the welding operations by an apparatus which is provided with a fixed bobbin tool, as another example of the conventional friction stir welding apparatus.

FIG. 11 is an enlarged diagram showing the fixed bobbin tool which is a welding tool of the conventional friction stir welding apparatus shown in FIG. 10.

### MODE FOR CARRYING OUT THE INVENTION

Referring to the drawings, friction stir welding apparatus and method as an embodiment of the present invention will be explained hereunder.

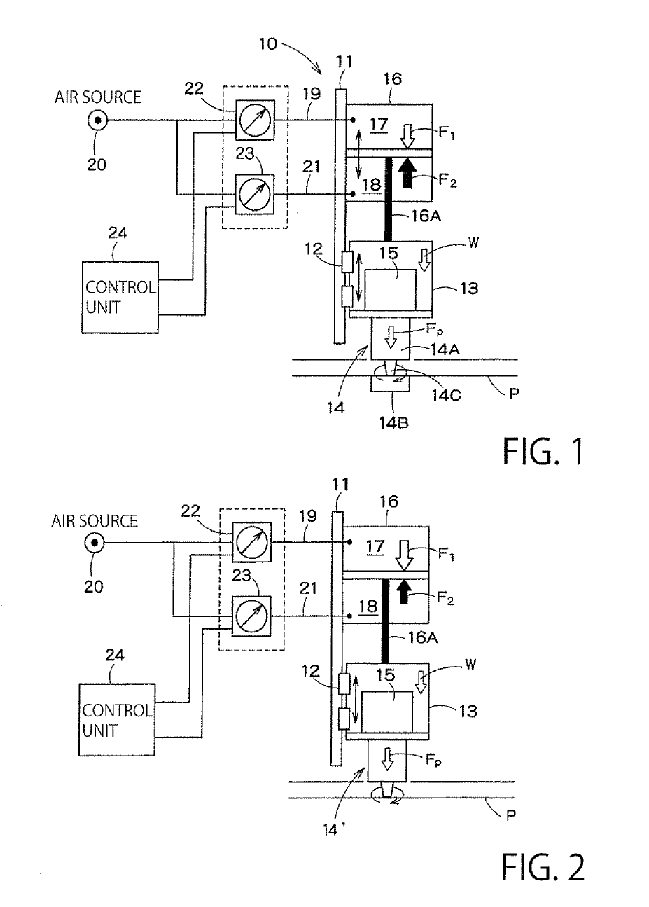

As shown in FIG. 1, the friction stir welding apparatus 10 according to the present invention includes a welding head 13 which is mounted on a head support part 11 of an apparatus body via a linear guide 12 so as to be linearly movable in the upward and downward directions. A welding tool 14 is rotatably mounted on the welding head 13, the welding tool 14 being configured to be made contact with workpieces P during a welding operation. The welding tool 14 is driven to rotate by means of a tool rotation drive motor (rotation drive unit) 15 which is mounted on the welding head 13.

An air cylinder (head drive unit) 16 for driving a head is fixedly mounted on the head support part 11. The welding head 13 is attached to a piston rod 16A of the air cylinder 16. Incidentally, the air cylinder 16 may be replaced with another cylinder actuator such as an oil cylinder actuator.

Compressed air is supplied from a compressed air source (compressed fluid source) 20 via a first pipe 19 into a first chamber 17 of the air cylinder 16. On the other hand, compressed air is supplied from the same compressed air source 20 via a second pipe 21 into a second chamber 18 of the air cylinder 16. The first pipe 19 and the compressed air source 20 constitute a first pressure unit which pressurizes the first chamber 17. The second pipe 21 and the compressed air source 20 constitutes a second pressure unit which pressurizes the second chamber 18.

A first pressure control valve 22 is disposed in the middle of the first pipe 19. A second pressure control valve 23 is disposed in the middle of the second pipe 21. The first pressure control valve 22 and the second pressure control valve 23 are controlled by means of a control unit 24 so that their pressure setting values are adjusted.

The welding tool 14 of the present embodiment is a fixed-type bobbin tool. The welding tool 14 includes a pair of upper and lower rotational members 14A, 14B which are disposed with a fixed space therebetween so as to make contact with the upper and lower faces of the workpieces P to be welded during a welding operation, and a stirring shaft 14C disposed between the upper and lower rotational members 14A, 14B so as to be inserted into the abutted portion of the workpieces P.

The distance between the upper and lower rotational members 14A, 14B are fixedly set taking into account the thickness of the workpieces P so that the upper rotational member 14A makes contact with the upper face of the workpieces P and the lower rotational member 14B makes contact with the lower face of the workpieces P.

When the friction stir welding apparatus 10 according to the present invention is used to weld the abutted portion of the workpieces P to be welded, while the welding tool 14 is being rotated by the tool rotation drive motor 15, the stirring shaft 14C of the welding tool 14 is moved along the abutment line in such a manner that the upper and lower rotational members 14A and 14B sandwich the workpieces P to be welded (refer to FIG. 10). In this case, the head support part 11 of the friction stir welding apparatus 10 may be moved with respect to the workpieces R On the contrary, the workpieces P may be moved while the head support part 11 is fixed. In short, it would be sufficient if the welding head 14 and the workpieces P move relative to each other.

Respective pressure setting values of the first pressure control valve 22 and the second pressure control valve 23 are adjusted by the control unit 24. Thereby, respective pressures of the first chamber 17 and the second chamber 18 of the air cylinder 16 for driving the head are controlled so as to maintain a state in which the upper rotational member 14A of the welding tool 14 is slightly pressed against the upper face of the workpieces P.

Namely, when the downward force due to the pressure of the first chamber 17 is defined as F1, the upward force due to the pressure of the second chamber 18 is defined as F2, and the downward force due to the own weight of the welding head 13 is defined as W, respective pressures of the first chamber 17 and the second chamber 18 are adjusted so that F1+W is slightly bigger than F2. In this case, when the pressing force from the upper rotational member 14A of the welding tool 14 against the upper face of the workpieces P is defined as Fp, F1+W−F2=Fp>0.

To the contrary, it would be also appropriate to maintain a state in which the lower rotational member 14B of the welding tool 14 is slightly pressed against the lower face of the workpieces P. In this case, respective pressures of the first chamber 17 and the second chamber 18 are adjusted so that F2 is slightly bigger than F1+W. Namely, when the pressing force from the lower rotational member 14B against the lower face of the workpieces P is defined as Fp, F2−F1−W=Fp>0.

As mentioned above, the welding tool 14 is moved along the abutment line of the workpieces P to be welded during the welding operation. During this operation, the positions of the faces of the workpieces P in the upward/downward directions may locally change (corrugate) due to due to the size errors and the mounting errors of the workpieces P.

If the upper face of the workpieces P is locally elevated upward, force is applied to the welding tool 14 at the elevated portion so as to push upward the upper rotational member 14A.

By the way, the conventional friction stir welding apparatus does not have any function that the fixed-type bobbin tool moves upward when force is applied to the same from the workpieces so as to push upward the bobbin tool. Therefore, a poor welding may be caused at the elevated portion of the workpieces P, and the strength of the welded portions may be inconstant.

On the other hand, in the present embodiment, the welding head 14 can be elastically supported in the upward/downward directions since the compressed air is supplied into both of the first chamber 17 and the second chamber 18 of the air cylinder 16 for driving the head so as to pressurize the first/second chambers 17, 18. Therefore, when upward (or downward) force is applied to the welding head 14 due to variation of the plate thickness of workpieces P, the welding head 14 is moved upward (or downward) according to the force. (Namely, the air cylinder 16 functions as an air dumper.) Thereby, even at the elevated portions (or recessed portions) of the workpieces P, a welding condition similar to those at the other portions can be maintained so that a poor welding and an inconsistent welding strength can be prevented from occurring.

According to the friction stir welding apparatus of the present invention, by adjusting respective pressures of the first chamber 17 and the second chamber 18 of the air cylinder 16 for driving the head, the upper rotational member 14A (or the lower rotational member 14B) of the welding tool 14 can be slightly pressed against the upper face (or lower face) of the workpieces P as mentioned above. Thereby, better welding condition can be achieved by using the fixed-type bobbin tool.

Moreover, in the fiction stir welding apparatus 10 according to the present embodiment, as shown in FIG. 2, a welding operation can be performed after the welding tool 14 of fixed-bobbin type has been replaced with the welding tool 14′ of one-side pressing type.

In this case, the first pressure control valve 22 and the second pressure control valve 23 are controlled by the control unit 24 so that F1+W is set to become sufficiently bigger than F2 so as to obtain a desired Fp. Preferably, the control unit 24 further includes a function to switch a control mode in which respective compressed airs are simultaneously supplied into the first chamber 17 and the second chamber 18 to an additional control mode in which the compressed air is supplied into only the first chamber 17. In this additional control mode, the compressed air is supplied from the compressed air source 20 into the first chamber 17, and the second chamber 18 is opened to the atmosphere. In this case, the compressed air from the compressed air source 20 can be supplied directly into the first chamber 17 without decreasing the pressure of the compressed air.

Moreover, when welding workpieces of soft materials such as a plastic material or of thin thickness, the pressure of the second chamber 18 may be set to become larger than the pressure of the first chamber 17 (F2>F1). Thereby, a part of the own weight (W) of the welding head is supported by the upward force (F2−F1) due to the pressure difference.

In this case, the control unit 24 is additionally provided with a function to switch a control mode in which respective compressed airs are simultaneously supplied into the first chamber 17 and the second chamber 18 to an additional control mode in which the compressed air is supplied into only the second chamber 18. In the additional control mode, the compressed air may be supplied from the compressed air source 20 into the second chamber 18 so as to support a part of the weight of the welding head 13, and the first chamber 17 is opened to the atmosphere.

Incidentally, using this additional control mode, while the compressed air is supplied into only the second chamber 18, a welding operation can be performed by means of the fixed-type bobbin tool shown in FIG. 1.

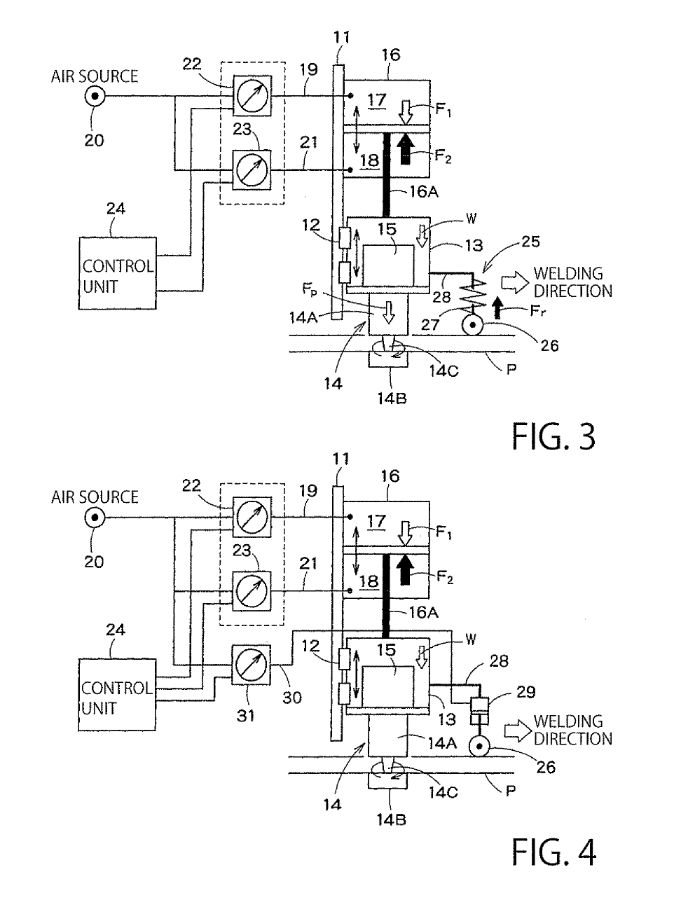

As mentioned above, in the embodiment shown in FIG. 1, the welding tool 14 can be moved in the upward/downward directions following the displacements in the upward/downward directions of the faces (upper/lower faces) of the workpieces P to be welded. In order to enhance the above-mentioned following function of this welding tool 14, a tool position correction mechanism 25 may be added as shown in FIG. 3.

This tool position correction mechanism 25 includes a roller member (contact member) 16 configured to be made contact with the upper face of the workpieces P during the welding operation, and a roller support member 28 including a compression spring (elastic support unit) 27 configured to elastically support the roller member 16 with respect to the welding head 13. The roller member 26 is disposed at the front side in the welding direction with respect to the welding tool 14. Incidentally, the roller member 26 can be positioned at the lateral side or the rear side in the welding direction instead of the front side, or the combination thereof.

In this tool position correction mechanism 25, force Fr is generated due to the elastic force of the compression spring 27 so as to push upward the welding head 13. When the pressing force from the upper rotational member 14A of the welding tool 14 against the upper face of the workpieces P is defined as Fp, Fp=F1+W−F2−Fr. When Fp=0, Fr=F1.+W−F2, and respective values are set such that Fr becomes zero or a given positive value.

When the workpieces P are deformed upward due to some variations of plate thickness, etc., the roller member 26 is pushed upward at the deformed portion so that the compression spring 27 is temporarily contracted. The force Fr for pushing upward is increased when the compression spring 27 is contracted so that the welding head 13 is pushed and moved upward. To the contrary, when the workpieces P are deformed downward, the compression spring 27 is elongated so that the force Fr for pushing upward is decreased and the welding head 13 descends.

As mentioned above, when the workpieces P are deformed upward (or downward), the welding head 13 is displaced upward (or downward) according to the deformations. Thereby, a poor welding or an inconsistent welding strength at the portions (elevated/recessed portions) can be prevented from occurring.

As a modification of the tool position correction mechanism 25, as shown in FIG. 4, an air cylinder 29 may be mounted instead of the compression spring 27. Incidentally, instead of the air cylinder, other cylinder actuators such as an oil cylinder actuator can be used.

Compressed air is supplied into the air cylinder 29 from the compression air source 20 via a third pipe 30. A pressure control valve 31 is disposed in the middle of the third pipe 30, and the pressure setting value thereof is controlled by the control unit 24,

In the example shown in FIG. 4, the roller member 26 is pressed against the upper face of the workpieces P by the air cylinder 29 of the tool position correction mechanism 25. Therefore, when the upper face of the workpieces P is locally deformed, the welding head 13 is displaced upward/downward following the deformations, similar to the example shown in FIG. 3.

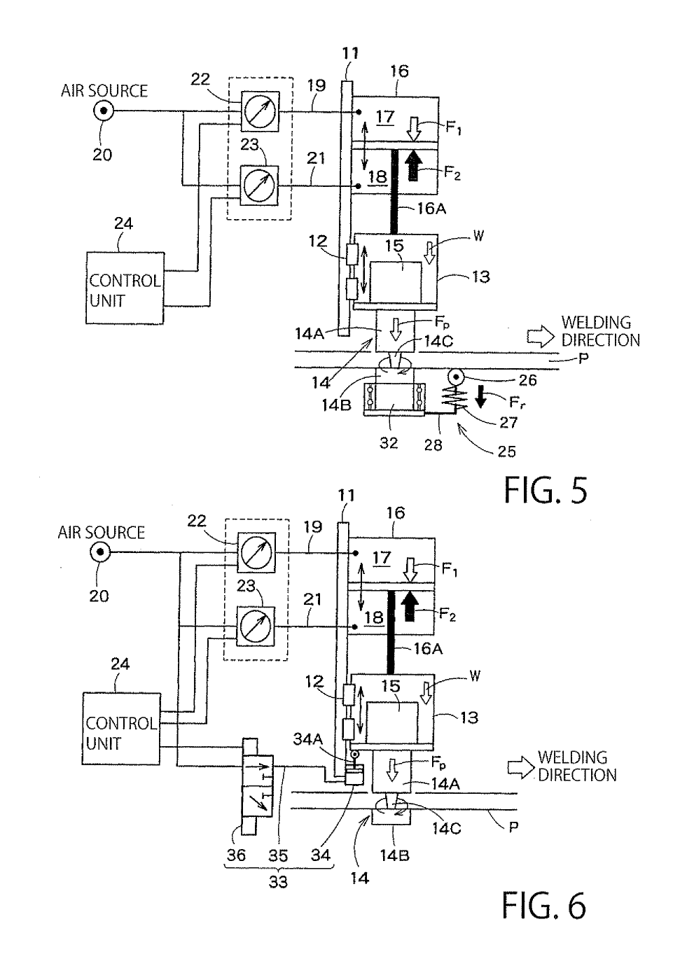

Moreover, in the examples shown in FIGS. 3 and 4, the roller member 26 is configured to make contact with the upper face of the workpieces P to be welded. However, the roller member 26 may be configured to make contact with the lower face of the workpieces P. FIG. 5 shows a constitution in which the roller member 26 is made contact with the lower face of the workpieces P, as a modification of the example shown in FIG. 3.

In the example shown in FIG. 5, a roller support member 28 is attached to the lower rotational member 1413 of the welding tool 14 via a bearing mechanism 32. The roller member 26 is disposed at the front side in the welding direction in such a manner that the roller member 26 is independent from the rotational movement of the lower rotational member 14B. Incidentally, the roller member 26 may be disposed at the lateral side or the rear side instead of the front side in the welding direction, or the combination thereof.

In the example of FIG. 5, the reaction force Fr due to the compression spring 27 is directed downward, thereby, Fp=F1+W−F2+Fr. When Fp=0, Fr=F2−W−F1, and respective values are set such that Fr becomes zero or a given positive value.

Next, FIG. 6 shows a modification of the embodiment shown in FIG. 1.

When the abutted portions of the workpieces P are welded by using the friction stir welding apparatus provided with the welding tool 14 comprising the fixed-type bobbin tool, in the initial stage of welding operation, there could be a phenomenon that the workpieces P are deformed and the welding tool 14 sinks.

In the initial stage of welding operation, the environment of welding (such as the stirring state of the workpieces P and temperature) has not yet become stable so that the frictional heat by the welding tool is locally supplied. Thereby, the workpieces P are excessively softened so that the pressing force Fp by the welding tool 14 cannot be supported by the workpieces P.

Then, in the example shown in FIG. 6, a head holding mechanism 33 is provided for holding the welding head 13 at a given height in the beginning of the welding operation. This head holding mechanism 33 includes an air cylinder 34 for holding the head disposed on the head support part 11. The distal end of the piston rod 34A of this air cylinder 34 is made contact with the welding head 13.

Compressed air is supplied into the air cylinder 34 from the compressed air source 20 via a fourth pipe 35. An electromagnetic valve 36 is disposed in the middle of the fourth pipe 35. The switching operation of the electromagnetic valve 36 is performed by the control unit 24.

When the abutted portions of the workpieces P are welded by using the friction stir welding apparatus shown in FIG. 6, in the beginning of the welding operation, the electromagnetic valve 36 is operated by the control unit 24 so that the compressed air from the compressed air source 20 is directly supplied into the air cylinder 34 without decreasing the pressure thereof. Thereby, the piston rod 34A of the air cylinder 34 is elongated so as to support the welding head 13 with the distal end thereof.

When the welding operation has proceeded to some extent and the welding environment is becoming stable, the electromagnetic valve 36 is operated by the control unit 24 so that the supply of the compressed air into the air cylinder 34 is stopped so as to contract the piston rod 34A. Thereby, the state becomes similar to the state in the case of the friction stir welding apparatus without the head holding mechanism (FIG. 1) so that the welding operation can be performed without any troubles after that.

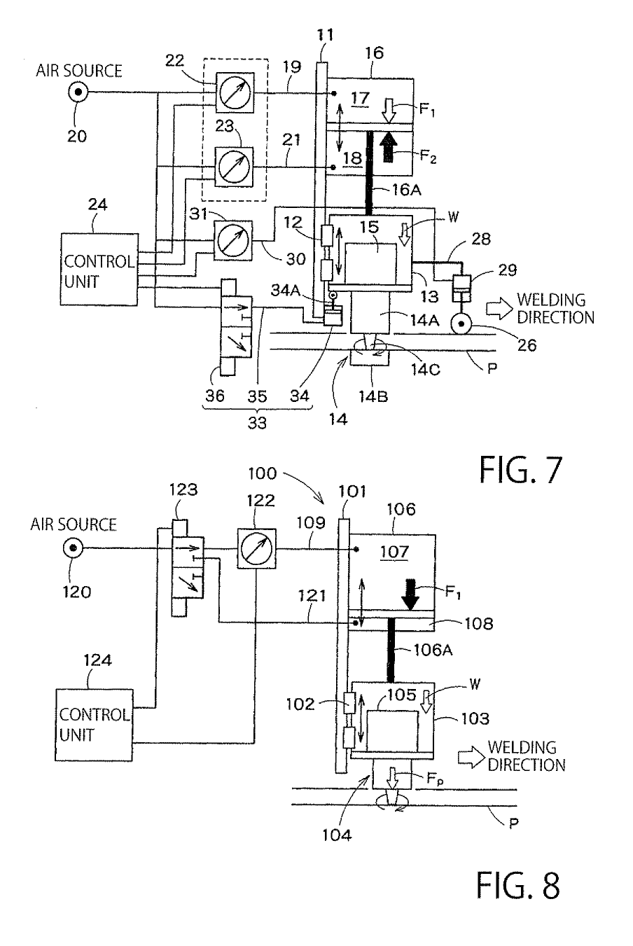

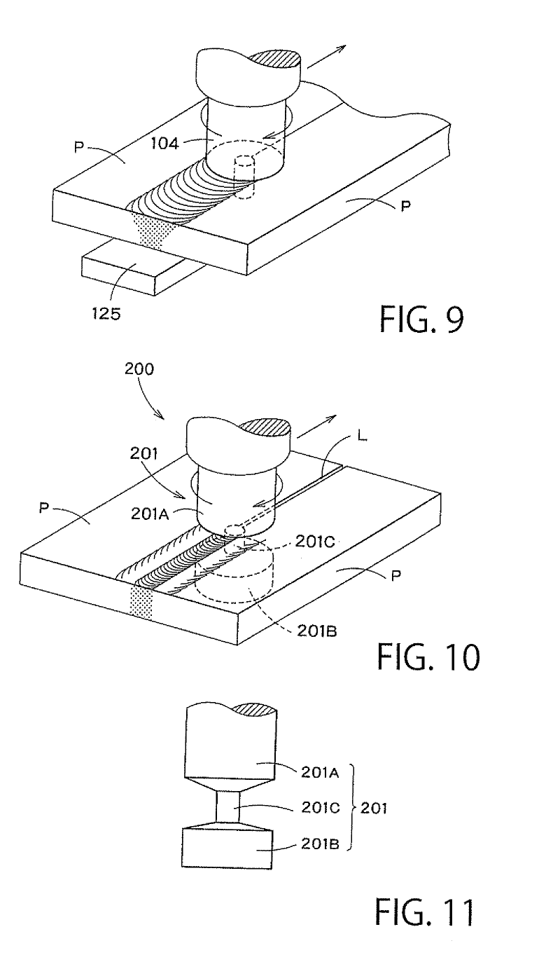

As a modification of the example shown in FIG. 6, the tool position correction mechanism shown in FIGS. 3 to 5 may be added thereto. FIG. 7 shows an example to which the tool position correction mechanism shown in FIG. 4 is added. According to the example shown in FIG. 7, it is possible to obtain the operational effect by the head holding mechanism in the initial stage of the welding operation, and the operational effect by the tool position correction mechanism in the later stage of the welding operation.

The preferable embodiments of the present invention have been described, and the above-mentioned embodiments can be appropriately changed within the scope of the present invention.

1. A friction stir welding apparatus comprising:
a welding head including a welding tool configured to be pressed against workpieces to be welded and a rotation drive unit configured to drive the welding tool to be rotated;
a head drive unit configured to drive the welding head to be displaced, the head drive unit including a cylinder actuator having a piston rod to which the welding head is attached;
a first pressure unit configured to supply a pressure fluid into a first chamber of the cylinder actuator;
a second pressure unit configured to supply a pressure fluid into a second chamber of the cylinder actuator;
a control unit configured to control pressures of respective pressure fluids which are simultaneously supplied into the first chamber and the second chamber by means of the first pressure unit and the second pressure unit.

2. The friction stir welding apparatus according to claim 1, wherein the welding tool is a fixed-type bobbin tool including a pair of rotational members which are disposed with a fixed space therebetween and a stirring shaft disposed between the pair of rotational members.

3. The friction stir welding apparatus according to claim 1, wherein the welding tool is configured to be pressed against only one side of the workpieces.

4. The friction stir welding apparatus according to claim 1, wherein the control unit is configured to control each of the pressures so that at least a part of a weight of the welding head is supported by a pressure difference between the pressure of the pressure fluid supplied from the first pressure unit and the pressure of the pressure fluid supplied from the second pressure unit.

5. The friction stir welding apparatus according to claim 1, wherein the first pressure unit and the second pressure unit are provided with a common pressure fluid source.

6. The friction stir welding apparatus according to claim 1, further comprising a tool position correction mechanism configured to displace the welding tool so as to follow a surface shape of the workpieces, the tool position correction mechanism including a contact member configured to be made contact with a surface of the workpieces and an elastic support unit configured to elastically support the contact member with respect to the welding head.

7. The friction stir welding apparatus according to claim 6, wherein the elastic support unit includes a compression spring or a cylinder actuator.

8. The friction stir welding apparatus according to claim 1, further comprising a head retaining mechanism configured to press the welding head in a direction moving away from the workpieces so as to retain the welding head at a given position.

9. The friction stir welding apparatus according to claim 8, wherein the head retaining mechanism includes a cylinder actuator having a piston rod which is made contact with the welding head.

10. The friction stir welding apparatus according to claim 1, wherein the control unit further has a switching mechanism configured to switch a control mode in which the respective pressure fluids are simultaneously supplied into the first chamber and the second chamber to an additional control mode in which the pressure fluid is supplied into only one of the first chamber and the second chamber.

11. The friction stir welding apparatus according to claim 10, wherein the additional control mode is a mode in which the workpieces are pressed by the welding tool configured to be pressed against only one side of the workpieces.

12. The friction stir welding apparatus according to claim 10, wherein the additional control mode is a mode in which at least a part of a weight of the welding head is supported by a pressure of the pressure fluid.

13. A friction stir welding method of welding workpieces by pressing a rotating welding tool against the workpieces so as to cause a plasticized fluidization, comprising:
a pressure control step of controlling pressures of respective pressure fluids which are simultaneously supplied to a first chamber and a second chamber of a cylinder actuator, the cylinder actuator including a piston rod to which a welding head having the welding tool is attached; and
a tool moving step of moving the welding tool along a welding line of the workpieces while the pressures of the respective pressure fluids are being controlled by the pressure control step.

14. The friction stir welding method according to claim 13, wherein a fixed-type bobbin tool is used as the welding tool, the fixed-type bobbin tool including a pair of rotational members which are disposed with a fixed space therebetween and a stirring shaft mounted between the pair of rotational members.

15. The friction stir welding method according to claim 13, wherein the welding tool is a welding tool configured to be pressed against only one side of the workpieces.

16. The friction stir welding method according to claim 13, wherein at least a part of a weight of the welding head is supported by a pressure difference between the pressure of the pressure fluid supplied into the first chamber of the cylinder actuator and the pressure of the pressure fluid supplied into the second chamber.

17. The friction stir welding method according to claim 13, wherein, in the tool moving step, the welding tool is displaced so as to follow a surface shape of the workpiece.

18. The friction stir welding method according to claim 13, wherein, when a welding operation is started, the welding head is pressed in a direction moving away from the workpieces so as to retain the welding head at a given position.

19. The friction stir welding method according to claim 18, wherein, after a welding condition has become stable, a retention of the welding head at the given position is released.
